(19) United States
(12) Patent Application Publication
(10) Pub. No.: US 2024/0350923 A1
(43) Pub. Date: Oct. 24, 2024

(54) Systems and Methods for Protecting Game Assets for Online Games

(71) Applicant: Six Impossible Things Before Breakfast Limited, Dublin (IE)

(72) Inventor: Sherry IGNATCHENKO, Weidling (AT)

(73) Assignee: Six Impossible Things Before Breakfast Limited, Dublin (IE)

(21) Appl. No.: 18/643,569

(22) Filed: Apr. 23, 2024

Related U.S. Application Data
(60) Provisional application No. 63/497,927, filed on Apr. 24, 2023.

(51) Int. Cl. A63F 13/71; H04L 9/06

(52) U.S. Cl. CPC A63F 13/71; H04L 9/06

(57) ABSTRACT

Systems and methods for protecting game assets for online games are described herein. The systems and methods described herein may be configured to perform obfuscated encryption of game assets used to render computer-generated three-dimensional models in online games. Code may be generated for encrypting a game asset using a bijective function. The code may consist of a set of pseudo-randomly generate bijection primitives, including at least one encryption algorithm. In some implementations, at least one of the bijection primitives may use encryption in counter (CTR) mode. In some implementations, the encryption key associated with the encryption algorithm and/or the code for the encryption algorithm may be obfuscated prior to being embedded within the generated code. Techniques for protecting game assets stored persistently and by obfuscating an encryption key using a key schedule are also described herein.

### RELATED APPLICATIONS

This application claims priority to U.S. Provisional Application No. 63/497,927, entitled “Method for Protecting Game Assets for Online Games,” filed on Apr. 24, 2023, the content of which is hereby incorporated herein by reference in its entirety.

### FIELD OF THE DISCLOSURE

The systems and methods described herein relate to improved techniques for protecting game assets for online games.

### BACKGROUND

In three-dimensional online games, various game assets are frequently used to express computer-generated graphics or three-dimensional models. Game assets include different three-dimensional objects such as characters, items, cars, furniture, buildings, or other structures. It is also common that third-party game assets are utilized. In such circumstances, there is often a license agreement required to utilize such game assets to protect the third party from the game assets being extracted when not in use (i.e., when not being rendered as a part of three-dimensional scene). Encryption keys are often used to enforce such license agreement and prevent the unauthorized use of such game assets. If an encryption key is compromised (i.e. lost, stolen, broken), however, it means that whatever information or rights it was intended to protect are also potentially compromised. Unfortunately, common practice of encrypting the assets while storing the encryption key as a simple constant within the client is rather easily circumvented. Ultimately, the problem of protecting assets which have to be extractable on the client-side still remains.

As such, there is a need for improved techniques for protecting game assets for online games.

### SUMMARY OF THE DISCLOSURE

This disclosure relates to systems and methods for protecting game assets for online games. According to one aspect of the invention, the systems and methods described herein may be configured to perform obfuscated encryption of game assets used to render computer-generated three-dimensional models in online games. In various implementations, the systems and methods described herein may be configured to generate code for encrypting a game asset using a bijective function. The code may consist of a set of bijection primitives. In various implementations, at least one of the bijection primitives may comprise an encryption algorithm. In various implementations, generating the code may comprise using the bijective function to pseudo-randomly generate parameters corresponding to each of the bijection primitives. In some implementations, at least one of the bijection primitives may comprise symmetric encryption in counter (CTR) mode. Counter parameters associated with the CTR mode and/or encryption keys associated with the encryption algorithm may be external to the generated code or embedded within the generated code. In some implementations, the encryption key associated with the encryption algorithm and/or the code for the encryption algorithm may be obfuscated prior to being embedded within the generated code. For example, in some implementations, the code for the encryption algorithm may be obfuscated in the bijection primitive. In some implementations, the generated code may be compiled into bytecode form. In such implementations, the resulting bytecode may be provided instead of an encryption key. In some implementations, an injection and surjection pair may be used instead of bijection to generate the code.

According to another aspect of the invention, the systems and methods described herein may be configured to protect game assets used to render computer-generated three-dimensional models in online games when those game assets are stored persistently. In various implementations, the systems and methods described herein may be configured to encrypt a game asset to be used to render a computer-generated three-dimensional model in an online game. In various implementations, the game asset may be encrypted using one or more of an asset key associated with the game asset, a game key associated with the online game, and a client key associated with a client computing device. In various implementations, the game asset may be encrypted using code consisting of bijection primitives. In such implementations, at least one of the bijection primitives may comprise an encryption algorithm. In implementations utilizing an asset key, the asset key may be provided to the client computing device by the game server. For example, the asset key may be provided to the client computing device with the encrypted game asset. In some such implementations, the asset key may be stored in memory at the client computing device and erased once no longer necessary. In implementations utilizing a game key, the game key may be embedded in code stored at the client computing device. In implementations utilizing a client key, the client key may be derived from attributes associated with the client computing device. For example, the attributes associated with the client computing device may include hardware attributes and/or other rarely changing attributes. In various implementations, the encrypted game asset may be transmitted to the client computing device, which may decrypt the game asset using at least one of the asset key, the game key, and the client key.

According to another aspect of the invention, the systems and methods described herein may be configured to decrypt assets (or process encrypted assets) when the asset is not made available in memory in its full original form. In some implementations, the systems and methods described herein may decrypt assets except for (a) one block (corresponding to a block of underlying crypto primitive) of unencrypted data, and (b) data necessary to be provided to destination APIs such as “draw calls.” In some implementations, a CTR encryption+ process described herein may be used to provide for random access to the file. In other implementations, the CTR encryption+ process may be used to implement temporary buffers with random access. In certain implementations, when generated bijection is used to implement temporary buffers with random access, generated bijection may use array access index(es) (or a function of array access index(es)) as constants within one or more bijection primitives.

According to yet another aspect of the invention, the systems and methods described herein may be configured to protect a game asset for an online game by obfuscating an encryption key using a key schedule. In various implementations, the systems and methods described herein may be configured to obtain an encryption key associated with a cryptographic algorithm. In some implementations, the cryptographic algorithm may comprise an Advanced Encryption Standard (AES) algorithm. In other implementations, the cryptographic algorithm may comprise a Twofish algorithm or a Speck algorithm. In various implementations, a key schedule may be generated based on the encryption key. In various implementations, the key schedule may be embedded into code associated with an online game and used to decrypt a game asset encrypted using the cryptographic algorithm. In some implementations, the key schedule may be used to decrypt a game asset without using a corresponding key directly.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to protect game assets used to render computer-generated three-dimensional objects within a virtual scene, according to one or more aspects described herein;

FIG. 2 depicts a flow diagram of an example of a method for performing obfuscated encryption of game assets used to render computer-generated three-dimensional models in online games, according to one or more aspects described herein;

FIG. 3 depicts a flow diagram of an example of a method for protecting game assets used to render computer-generated three-dimensional models in online games when those game assets are stored persistently, according to one or more aspects described herein; and

FIG. 4 depicts a flow diagram of an example of a method for protecting a game asset for an online game by obfuscating an encryption key using a key schedule, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

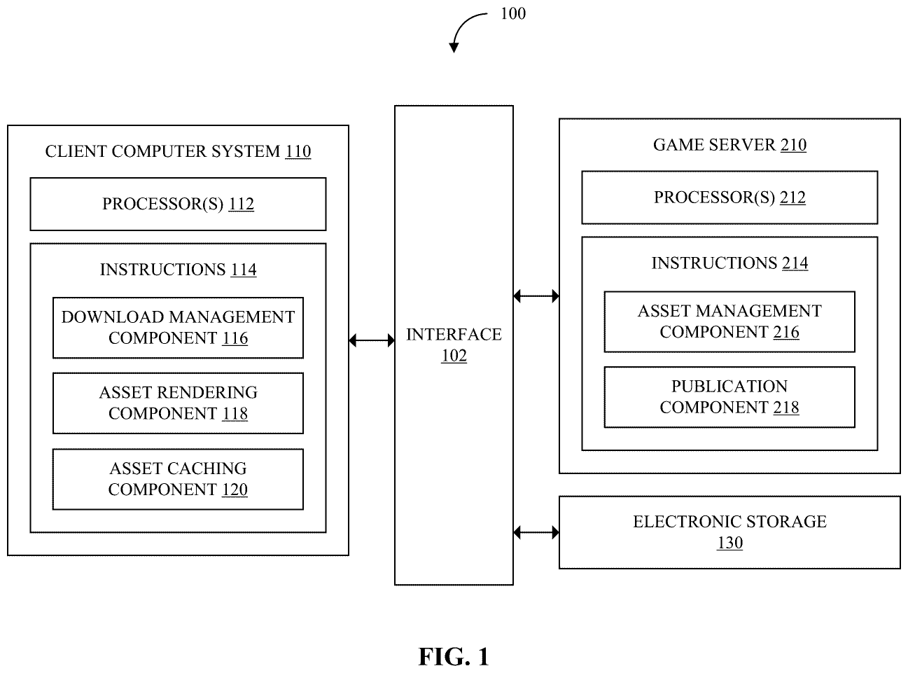

FIG. 1 illustrates an example of a system 100 configured to protect game assets used to render computer-generated three-dimensional objects within a virtual scene, according to one or more aspects described herein. In various implementations, system 100 may include one or more of an interface 102, at least one client computer system 110, electronic storage 130, a game server 210, and/or other components. In various implementations, client computer system (or device) 110 may comprise a game client computing system (or device). In various implementations, client computer system 110 may be configured to receive instructions and game state data related to an online game comprising three-dimensional virtual scenes from game server 210. In various implementations, client computer system 110 may be configured to receive game assets from game server 210 for rendering within the three-dimensional virtual scenes based on the instructions and game state data. In various implementations, client computer system 110 may include one or more physical processors 112 (also interchangeably referred to herein as processor(s) 112, processor 112, or processors 112 for convenience), computer readable instructions 114, and/or one or more other components. In various implementations, game server 210 may include one or more physical processors 212 (also interchangeably referred to herein as processor(s) 212, processor 212, or processors 212 for convenience), computer readable instructions 214, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via client computer system 110 and/or game server 210.

In various implementations, processor(s) 112, 212 may be configured to provide information processing capabilities in system 100. As such, the processor(s) 112, 212 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112, 212 may be configured to execute one or more computer readable instructions 114, 214. Computer readable instructions 114, 214 may include one or more computer program components. In various implementations, computer readable instructions 114 may include one or more of download management component 116, asset rendering component 118, asset caching component 120, and/or one or more other computer program components, and computer readable instructions 214 may include one or more of asset management component 216, publication component 218, and/or other computer program components. As used herein, for convenience, the various computer readable instructions 114, 214 will be described as performing an operation, when, in fact, the various instructions program the processor(s) 112, 212 (and therefore client computer system 110 or game server 210) to perform the operation.

In various implementations, client computer systems 110 may subscribe to receive game updates from a game server 210 related to an online game. For example, game server 210 may “publish” game state, and one or more of client computer system 110 may “subscribe” to receive the published game state. As a result of such a “subscription” by a client computer system 110, game server 210 may (a) send client computer system 110 a current game state, (b) include client computer system 110 (identified, for example, by its IP address and/or network socket which is used to communicate with client computer system 110) on a list of “subscribers” for this “publication,” and (c) whenever published game state is updated (for example, as a result of user inputs sent to the game server and/or as a result of simulation), game server 210 may send the update to the game state to all the current “subscribers.” In response to the updated game state data and/or as otherwise necessary, client computing system 110 may be configured to download game assets from game server 210 for rendering within virtual scenes of the game. To that end, in various implementations, asset management component 216 may be configured to generate, organize, encode, and/or otherwise manage game assets used to render a virtual scene. For example, game assets may comprise the three-dimensional objects that, when rendered, make up a virtual scene in a game. In some implementations, system 100 may be configured to utilize one or more techniques to provide, receive, and utilize a “published” game state as described, for example, in U.S. patent application Ser. No. 18/630,409, entitled “SYSTEMS AND METHODS FOR INCREMENTAL DYNAMIC LOADING OF GAME ASSETS,” filed Apr. 9, 2024, the contents of which are hereby incorporated by reference herein in their entirety.

In various implementations, publication component 218 may be configured to publish data regarding a current state of the game. For example, in various implementations, a publication may include a current level, list of items and/or non-player characters (NPCs) with identifiers for their three-dimensional models and/or their coordinates. In various implementations, client computer system 110 may be configured to request digital assets (which may be interchangeably referred to herein as “game assets”) from game server 210, which may be provided in the form of downloadable resources. In some implementations, client computer system 110 may be configured to request and download said digital assets in response to receiving a publication from the game server 210 indicating at least a current state of a game. In some implementations, client computer system 110 may be configured to load digital assets directly from storage accessible by client computer system 110 (i.e., without having to request digital assets from game server 210). In either case, digital assets to be loaded by client computer system 110 may be stored by game server 210 (and available for request by client computer system 110) and/or stored in electronic storage accessibly by client computer system 110, and such digital assets may be compressed, encrypted, and stored according to the one or more techniques described herein.

In various implementations, asset management component 216 may be configured to protect game assets using a bijective function. For example, asset management component 216 may be configured to encrypt a game asset using a bijective function. In various implementations, asset management component 216 may be configured to generate a bijective function (i.e., acting as a “bijection generator”). A bijective function is a 1-to-1 correspondence function. Specifically, as used herein with respect to system 100, such a “function” is a “programming function” as opposed to a “mathematical function.” In a bijective function, each element of one set is paired with exactly one element of the other set, and each element of the other set is paired with exactly one element of the prior set. In various implementations, asset management component 216 may be configured to operate on a byte array that is 2\hat{ }n (or 2″) bytes in size, taking a byte array of the same size as input and returning it as an output, or taking it by reference and modifying it. For example, if the bijective function operates on a 32-bit integer, asset management component 216 may be configured to operate on a 4-byte byte array (where each byte comprises 8 bits).

In various implementations, a bijective function used by asset management component 216 may be made out of a pre-defined set of one or more bijection primitives. For example, the one or more bijection primitives may comprise one or more of an XOR with constant (such as part of a key), adding a constant (such as part of key) (implying addition modulo 2\hat{ }32, 2\hat{ }64 etc.), bit-wise rotations, multiplication by an odd constant modulo 2\hat{ }N, bit-wise shift followed by XOR-with-original, a round of Feistel network (using not-necessarily-bijective function-which enables even more choices when generating the function to be used by Feistel round), an XOR with PRNG output (e.g., with any kind of PRNGs), symmetric encryption algorithms, and/or other types of encryption or crypto primitives. For examples, a bijective function may be made out of a pre-defined set of bijection primitives as described in “Bot Fighting 201: Declarative Data+Code Obfuscation with Build-Time Polymorphism in C++” by “No Bugs” Hare, translated by Sergey Ignatchenko, posted Dec. 26, 2017, and available at http://itharc.com/bot-fighting-201-declarative-datacode-obfuscation-with-build-time-polymorphism-in-c/(last visited Apr. 22, 2024). In some implementations, bijection primitives may include one or more parameters. For example, bijection primitives such as “add constant modulo 2\hat{ }32” and “multiply by an odd constant modulo 2\hat{ }32” may each have a 32-bit parameter “which constant to use.”

In various implementations, asset management component 216 may be configured to generate a bijective function that takes a bijection key as a parameter. In various implementations, asset management component 216 may be configured to use a pseudo-random generator initialized (seeded) with the bijection key. The pseudo-random generator may be any type of pseudo-random generator, for example, a linear congruential generator (LCG), or a cryptographic pseudo-random number generator (CPRNG). In various implementations, the asset management component 216 may take several steps to generate a bijective function using pseudo-random generator. At the beginning of the process, a bijection function may be an identity function, and then each of the steps may add a bijection primitive to the bijection function, choosing this bijection primitive from a list of pre-defined bijection primitives according to the output of the pseudo-random generator. At the end of the process, the resulting “generated” bijective function may be used for encryption and/or obfuscation purposes as described herein. In some implementations, one or more of pre-defined bijection primitives may use some parameters (such as, for example, an XOR parameter or a multiplication parameter). In such implementations, these parameters may generated using output of pseudo-random number generator. In various implementations, this process may continue until a pre-specified metric is reached. For example, each bijection may be assigned its estimated cost in CPU cycles, and continue the process until the pre-specified cost is reached.

In various implementations, when generating a bijection (or bijective function), asset management component 216 may be configured to generate at least two pieces of source code. For example, asset management component 216 may be configured to generate a first piece of code which performs a generated bijection and a second piece of code which performs a reverse bijection.

In various implementations, if bijection is needed to operate on a larger array (e.g., where size of a larger-array is a multiple of a size of an original bijection), asset management component 216 may be configured to use the same bijection multiple times with the same parameter and/or different parameters.

In various implementations, asset management component 216 may be configured to add one or more of symmetric encryption algorithms as bijection primitives. For example, the one or more of symmetric encryption algorithms may include, but are not limited to, Advanced Encryption Standard (AES), Twofish, Speck, Chacha20, and Xchacha20 encryption algorithms. Typically, modern encryption algorithms operate on 128-bit/16-byte arrays (known as blocks) so respective primitives would operate on 16-byte arrays (though in some implementations, block size may be different). In some such implementations, the encryption key used may be generated from the same bijection key-based pseudo-random generator. In other implementations, an externally-supplied encryption key may be used. In some implementations, asset management component 216 may be configured to use one block of symmetric encryption in Electronic Code Book (ECB) mode to make a bijection primitive. In other implementations, asset management component 216 may be configured to use one block of symmetric encryption in CTR (or Counter) mode to make a bijection primitive. In such implementations, additional “counter” parameter may be needed to pass to the primitive. In some implementations, asset management component 216 may be configured to further obfuscate code of encryption algorithms using a bijection primitive. In some implementations, asset management component 216 may be configured to obfuscate the encryption key. In various implementations, the obfuscation of an encryption keys, code for an encryption algorithm, and/or any other items discussed herein may be performed using, for example, one or more bijection primitives discussed herein. For example, code of encryption algorithms used a bijection primitive and/or the encryption key may be obfuscated using techniques described in “C++ Code+Data Obfuscation Library with Build-Time Polymorphism,” available at https://github.com/ITHarc/obf (last visited Apr. 22, 2024).

In various implementations, asset management component 216 may be configured to generate code including at least one encryption primitive. In some implementations, asset management component 216 may be configured to only generate code that includes at least one encryption primitive. Such bijections (or bijective functions) that include at least one encryption primitive may be referred to herein as “encryption+.” Not accounting for side-channel attacks, this construct would be at least as strong as an original encryption algorithm. In various implementations, asset management component 216 may be configured to generate one or multiple types of code including at least one encryption primitive. For example, in some implementations, code including at least one encryption primitive may comprise code in which encryption keys for all crypto primitives used in the generated bijection are embedded into the generated code and/or code in which at least one of the encryption keys is taken as an external parameter. As used herein, code including at least one encryption primitive in which encryption keys for all crypto primitives used in the generated bijection are embedded into the generated code may be referred to herein as “encryption+ with embedded key.” In some implementations using “encryption+ with embedded key,” encryption keys for crypto primitives used in the generated bijection may be embedded into the generated code in obfuscated form. As used herein, code in which at least one of the encryption keys is taken as an external parameter may be referred to herein as “encryption+ with external key.”

In various implementations, if CTR mode is used by asset management component 216 to make at least one of the crypto-based primitives, both code in which encryption keys for all crypto primitives used in the generated bijection are embedded into the generated code (“encryption+ with embedded key”) and code in which at least one of the encryption keys is taken as an external parameter (“encryption+ with external key”) would require an additional “counter” parameter. For example, and more generally, both types of code including at least one encryption primitive would require a “counter combined with nonce” parameter. As used herein, such generated bijections (i.e., code including at least one encryption primitive used with CTR mode) may be referred to herein as “CTR encryption+.” Such bijections may be used to implement CTR-mode encryption of larger pieces of data, for example, by supplying usual CTR-like counter (or “counter combined with nonce”) as a parameter to the generated bijection. In one non-limiting example, the “counter” parameter may correspond to the number of the encryption block within the encrypted file or stream (e.g., where size of the encryption block may correspond to the size of the block of encryption algorithm used).

In some implementations, asset management component 216 may be configured to generated sequence of bijections in which encryption primitive(s) always comes first. In such implementations, the “encryption+” code would be strictly at least as strong as an original encryption algorithm, even in presence of side-channel attacks. Notably, the “encryption+” code described herein represents an improved encryption that carries its own key within the encrypting/decrypting code and cannot be decrypted having only the encryption key. Instead, an attacker would need to have the generated code. Or an attacker would require knowledge of the whole bijection key, but the bijection key is not included in the code in any form, except that in the form of the code. These techniques differ from existing techniques, as it is strongly discouraged in cryptography to write (let alone generate) any crypto primitives. Rather, common practice is to use standard cryptography primitives and not to invent your own ones.

In various implementations, to protect game assets, system 100 may be configured to utilize one or more layers of “CTR encryption+.” For example, when storing a game asset to be transmitted over the network (e.g., on a web server), asset management component 216 may be configured to encrypt the asset using “CTR encryption+.” Indeed, in various implementations, asset management component 216 may be configured to encrypt assets, when the assets are transmitted over the network, using “CTR encryption+” with an external “asset key”. In some implementations, this “asset key” may be supplied to the game client (e.g., client computer system 110) together with an identification of the asset. For example, in some implementations, if a subscription is utilized to receive instructions and game state data (e.g., as described in U.S. patent application Ser. No. 18/630,409), game server 210 may be configured to “publish” the asset key alongside an asset identifier (or ID). In some implementations, the asset key may correspond to more than one asset ID. In some implementations, the asset key may be stored in-memory only, and may be erased on the program exit. Additionally, the asset key may be erased in response to a determination, or instructions indicating, that it is no longer needed. For example, the asset key may be erased (or no longer be accessible) when the asset key no longer appears in the publication from the game server. This may help to reduce attack surface. In particular, it may make assets non-extractable unless the client is “live.” For example, it may make assets non-extractable unless the client is actively rendering a virtual scene within a game or otherwise active. In some implementations, asset management component 216 may be configured to encrypt game assets using “CTR encryption+” with a “game key.” A “game key” may comprise a game-specific key embedded into the game client, for example, for use as part of the implementation of “CTR encryption+.”

In various implementations, when transferring assets over the network (e.g., over HTTP and/or using methods as described in U.S. patent application Ser. No. 18/630,409), asset management component 216 may be configured to further encrypt game assets using Transport Layer Security (TLS) or Datagram Transport Layer Security (DTLS), for example, directly, or by using protocols such as HTTPS or QUIC.

On the client-side (e.g., at client computer system 110), download management component 116 may be configured to download game assets to be rendered from game server 210. For example, download management component 116 may be configured to request a downloadable resource corresponding to a game asset in response to instructions or published game state data received from game server 210. In various implementations, asset rendering component 118 may be configured to render game assets within a virtual scene, and asset caching component 120 may be configured to cache game assets for subsequent use, for example, by asset rendering component 118 to render a virtual scene. In some implementations, asset caching component 120 may be configured to store (or cache) game assets persistently at client computer system 110, on electronic storage 130, and/or in storage otherwise accessible by client computer system 110 using one or more techniques described, for example, in U.S. patent application Ser. No. 18/630,409.

In various implementations, when storing (or caching) a game asset, asset caching component 120 may be configured to store the asset either in “resource” form (as it was received from game server 210) or in an “asset” (usually GPU-friendly) form. To produce “asset” form from “resource” form, client computer system 110 may, for example, be configured to decompress the asset and/or convert it to a GPU-friendly form. To store the asset in “resource” form, asset caching component 120 may be configured to maintain an already-existing “asset key” encryption+ and/or “game key” encryption+. In some implementations, asset caching component 120 may be configured to maintain the already-existing “asset key” encryption+ and/or “game key” encryption+, while also adding “client key” encryption+, as described further herein. To store the asset in “asset” form, asset caching component 120 may be configured to re-encrypt the asset using “asset key” encryption+, “game key” encryption+, and/or “client key” encryption+.

In various implementations, “client key” encryption+ may comprise “CTR encryption+” with an external “client key” derived from characteristics of a client device (i.e., client computer system 110). In such implementations, even if a file stored on client computer system 110 is transferred to a different client computer system 110, the file will not be decrypted correctly due to external “client key.” In some implementations, download management component 116 may be configured to derive a “client key” for its client computer system 110, for example, from a device-provided device identification (such as an ANDROID_ID on Android devices or a UIDevice.identifierForVendor on iOS devices) or from a “fingerprint” string (for example, using conventional techniques for deriving keys from passwords). In implementations in which a “fingerprint” string is used, the client key may be concatenated from several attributes which are specific to client device and which are not likely to change. For example, such attributes may include hardware attributes (such as CPU type, GPU type, amount of physical RAM and/or VRAM, size(s) of physical HDDs/SSDs, hard disk serial number(s), MAC ID(s) of the network card(s), and/or other hardware attributes) and/or other rarely changing attributes, such as volume serial number(s), partition size(s), and/or similar device attributes.

In various implementations, download management component 116 may be configured to avoid storing the entirety of an asset in memory when decrypting assets. In some implementations, operations to avoid (or limit) storing the entirety of an asset in memory may be restricted to only higher level of details (LODs) (i.e., leaving lower-LODs unprotected while they are in memory).

In some implementations, download management component 116 may be configured to use (or include) a data loader to convert data from asset data format to “destination APIs” or to an intermediate buffer for further re-encoding. For example, convert data from asset data format to “destination APIs” calls, such as OpenGL, DircetX, Vulcan, and/or other APIs (referred to herein as “draw calls”), which may instruct an API how to render an asset. In some implementations, data loader may include a GLTF JSON parser, a mesh loader, a texture format decoder, and/or other features.

In some implementations, data loader may be stream-based. In such implementations, download management component 116 may be configured to simply decrypt the data, buffering not more than one single block of unencrypted data. In such implementations, the size of one single block may correspond to crypto block size, which is usually 16-bytes. In some implementations, data loader may require random access. In such implementations, download management component 116 may be configured to rely on CTR nature of encryption technique described herein, and may implement “seek” function for the data stream, again with not more than one single block of unencrypted asset data in memory. This approach may help to avoid storing the entirety of the unencrypted asset in memory.

In some implementations, when intermediate buffers are necessary (e.g., when re-compressing textures as described in U.S. patent application Ser. No. 18/630,409), download management component 116 may be configured to temporarily encrypt intermediate buffers. For example, download management component 116 may be configured to temporarily encrypt intermediate buffers using “CTR encryption+,” as described herein, and use CTR mode to perform random access. In such implementations, the key for such encryption may be embedded into or within client computer system 110. Such a key may comprise a “game key,” a “client key,” and/or any other type of key, including a generated temporary key.

In some implementations, when generating bijection to access intermediate buffers organized as arrays with one or more indexes, asset management component 216 may be configured to use bijection primitives that use indexes (or some function of indexes) instead of a “constant.” For example, such intermediate buffers organized as arrays with one or more indexes may include a texture intermediate buffer including a 2D array with Xindex, Yindex pair used to address a pixel within. In an example implementation, asset management component 216 may be configured to use a bijection primitive that uses Xindex, Yindex pair as an external parameter, puts the pair into one 32-bit integer (i.e., one starting at 16 bits), multiplies this 32-bit integer by a large odd constant, and generates an exclusive-OR (“XOR”) with (or adds modulo 32 to) a pixel represented as 32-bit (e.g., 32-bit RGBA). This may help to further obfuscate data in intermediate buffers (or any other buffers with indexed access). In some implementations, download management component 116 may be configured to use simpler and computationally cheaper generated bijections (i.e., instead of “CTR encryption+”) for temporary encryption.

In some implementations, a mesh (or a texture) may be required in full in memory right before a draw call to render a game asset. While such three-dimensional representations usually have a more complicated structure than one single block of memory, and therefore are not that easily extracted from memory as full unencrypted asset, it still may be desirable to minimize time of such exposure. In such cases, download management component 116 may be configured to erase this mesh or texture from memory as soon as possible (e.g., in response to a determination, or instructions indicating, that it is no longer needed). In some other implementations, download management component 116 may be configured to obfuscate (using bijections, encryption, and/or “encryption+,” as described herein) contents of the whole or parts of the meshes and/or textures. In one non-limiting example, download management component 116 may be configured to XOR (or encrypt+) vertex buffer of the mesh between draw calls, restoring it to unencrypted form only for the duration of the draw calls.

In some implementations, asset management component 216 may be configured to use public cryptography instead of (or in addition to) symmetric cryptography. For example, asset management component 216 may be configured to put a symmetric key used for encryption in encrypted-with-some-private-key-form within the resource itself. In other implementations, asset management component 216 may be configured to apply public cryptography in a manner similar to how symmetric cryptography is applied as described herein.

In some implementations, instead of passing a key, asset management component 216 may be configured to generate and compile “encryption+” code (which may contain the code to decrypt data using the key, but without storing the key itself) to bytecode format, such as WebAssembly (“WASM”), and then pass this decrypting code in lieu of the key. Such a technique may be used, for example, for “asset key” encryption. In some implementations, bytecode format may selectively (or optionally) include only bijections with only encryption-method-id and a key being passed along with it. In some implementations, bytecode (or parts of bytecode) may be compressed using one or more techniques described in U.S. patent application Ser. No. 18/438,702, entitled “SYSTEMS AND METHODS FOR IMPROVING COMPRESSION OF STRUCTURED DATA IN THREE-DIMENSIONAL APPLICATIONS,” filed Feb. 12, 2024, the content of which is hereby incorporated by reference herein in its entirety. For example, in some implementations, bytecode may be compressed using methods described in U.S. patent application Ser. No. 18/438,702 for compressing executables. In some implementations, asset management component 216 may be configured to store and/or pass bytecode over the network instead of passing the key.

In some implementations, some or all of the “encryption+” methods described herein may be replaced with traditional encryption. As used herein, “traditional encryption” can be considered a subset of “encryption+”—with no bijections added.

In some implementations, asset management component 216 may be configured to use an injection/surjection pair instead of bijection. For example, in such implementations, asset management component 216 may be configured to use injection for encoding, and surjection for decoding. Notably, in some of such implementations, injection may result in increasing the size of the data block.

In some implementations, for specific cryptographic algorithms, when generating bijections using an embedded key (e.g., as described herein with respect to “game key” encryption+), asset management component 216 may be configured to generate a derivative from the key. For example, asset management component 216 may be configured to generate a key schedule for Advanced Encryption Standard (AES), Twofish, or Speck from the key. In such implementations, asset management component 216 may then be configured to embed the key schedule into generated bijection (i.e., instead of the key itself). In such implementations, asset management component 216 may be configured to avoid having “key” within the code, thereby complicating efforts by a potential attacker to retrieve the key from the code. In some implementations, the key schedule may be further obfuscated. For example, in some implementations, the key schedule may be further obfuscated using methods described in “Bot Fighting 201: Declarative Data+Code Obfuscation with Build-Time Polymorphism in C++” by “No Bugs” Hare, translated by Sergey Ignatchenko, posted Dec. 26, 2017, and available at http://ithare.com/bot-fighting-201-declarative-datacode-obfuscation-with-build-time-polymorphism-in-c/(last visited Apr. 22, 2024), methods described in “Bot Fighting 201, Part 2: Obfuscating Literals” by “No Bugs” Hare, translated by Sergey Ignatchenko, posted Jan. 2, 2018, and available at http://ithare.com/bot-fighting-201-part-2-obfuscating-literals/(last visited Apr. 22, 2024), and/or methods described in “C++ Code+Data Obfuscation Library with Build-Time Polymorphism,” available at https://github.com/ITHare/obf (last visited Apr. 22, 2024), each of which is hereby incorporated by reference herein in its entirety.

While various operations are described herein as being performed by the client computer system 110 or the game server 210 (or one or more components of client computer system 110 or game server 210), it is to be understood that, unless explicitly indicated otherwise, each of the one or more operations described herein as being performed by a client computer system 110 could be performed by a game server 210 and that each of the operations described herein as being performed by a game server 210 could be performed by a client computer system 110. For example, one or more techniques described as being used by game server 210 to encrypt or obfuscate game assets, code, and/or other items associated with an online game could also (or instead) be used by client computer system 110 to re-encrypt or obfuscate game assets, code, and/or other items associated with an online game.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., client computer system 110, processor(s) 112, game server 210, and/or other components). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor(s) 112, information received remotely, and/or other information that enables system 100 to function properly. For example, electronic storage 130 may store standard three-dimensional meshes or models, information relating to one or more three-dimensional meshes or models, one or more meshes, one or more textures, one or more normal maps, and/or other information related to the systems and methods described herein.

Game server 210 may comprise a remote server configured to provide publications and game state data related to an online game comprising three-dimensional virtual scenes to client computer system 110. In some implementations, game server 210 may be configured to provide to client computer system 110 publications related to an online game that include cause three-dimensional object(s) to be rendered within a virtual scene. For example, a publication may cause a virtual scene to be constructed comprising at least one object to be generated based on a generic asset, a base texture, and an asset received in response to a request. In various implementations, game server 210 may be configured as a server device (e.g., having one or more server blades, processors, etc.) and/or as another device capable of providing publications and game state data related to an online game to client computer system 110.

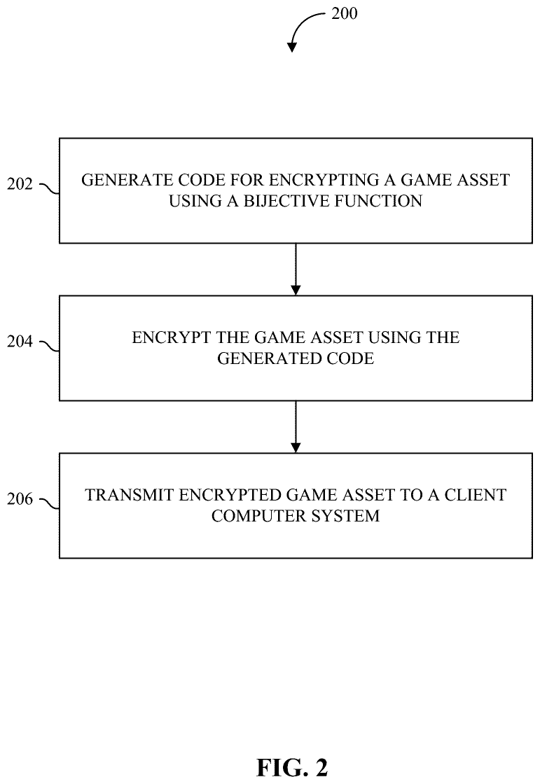

FIG. 2 illustrates an example of a process 200 for performing obfuscated encryption of game assets used to render computer-generated three-dimensional models in online games, according to one or more aspects described herein. The operations of process 200 presented below are intended to be illustrative and, as such, should not be viewed as limiting. In some implementations, process 200 may be accomplished with one or more additional operations not described, and/or without one or more of the operations discussed. In some implementations, two or more of the operations of process 200 may occur substantially simultaneously. The described operations may be accomplished using some or all of the system components described in detail above.

In an operation 202, process 200 may include generating code for encrypting a game asset using a bijective function. In various implementations, the code may consist of bijection primitives. In various implementations, at least one of the bijection primitives may comprise an encryption algorithm. In various implementations, generating the code may comprise using the bijective function to pseudo-randomly generated parameters corresponding to each of the bijection primitives. In some implementations, at least one of the bijection primitives may comprise symmetric encryption in counter (CTR) mode. In some such implementations, a counter parameter associated with the CTR mode may be external to the generated code. In other such implementations, the counter parameter associated with the CTR mode may be external to the generated code. In some implementations, an encryption key associated with the encryption algorithm may be provided external to the generated code. In other implementations, an encryption key associated with the encryption algorithm is embedded within the generated code. In some implementations, the encryption key associated with the encryption algorithm and/or the code for the encryption algorithm may be obfuscated prior to being embedded within the generated code. For example, in some implementations, the code for the encryption algorithm may be obfuscated using one or more bijection primitives. In various implementations, the obfuscation of encryption keys, code for an encryption algorithm, and/or any other items discussed herein may be performed using, for example, one or more bijection primitives discussed herein. In some implementations, the generated code may be compiled into bytecode form, wherein the resulting bytecode may be provided instead of an encryption key. In an operation 204, process 200 may include encrypting the game asset using the generated code. In an operation 206, process 200 may include transmitting the encrypted game asset to a client computing device, wherein the game asset may be decrypted at the client computing device using the generated code.

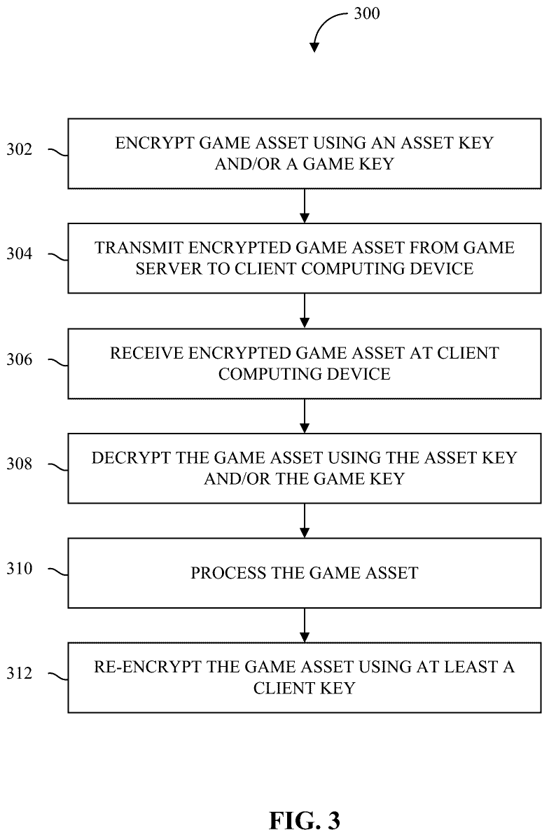

FIG. 3 illustrates an example of a process 300 for protecting game assets used to render computer-generated three-dimensional models in online games when those game assets are stored persistently, according to one or more aspects described herein. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations of process 300 may occur substantially simultaneously. The described operations may be accomplished using some or all of the system components described in detail above.

In an operation 302, process 300 may include a game server encrypting a game asset to be used to render a computer-generated three-dimensional model in an online game. In various implementations, the game asset may be encrypted using one or more of an asset key associated with the game asset and a game key associated with the online game. In various implementations, the game asset may be encrypted using code consisting of bijection primitives. In such implementations, at least one of the bijection primitives may comprise an encryption algorithm. In implementations utilizing an asset key, the asset key may be provided to the client computing device by the game server. For example, the asset key may be provided to the client computing device with the encrypted game asset. In some such implementations, the asset key may be stored in memory at the client computing device and erased once no longer necessary. In implementations utilizing a game key, the game key may be embedded in code stored at the client computing device. In an operation 304, process 300 may include the game server transmitting the encrypted game asset to the client computing device, wherein the game asset may be decrypted at the client computing device using at least one of the asset key and the game key.

In an operation 306, process 300 may include the client computing device (also interchangeably referred to herein as the “game client”) receiving the game asset encrypted using one or more of the asset key associated with the game asset and the game key associated with the online game. In an operation 308, process 300 may include the client computing device decrypting the game asset using one or more of the asset key and the game key. In an operation 310, process 300 may include the client computing device processing the game asset. For example, processing the game asset may include decompressing the game asset and/or converting the game asset to a GPU-friendly form. In an operation 312, process 300 may include the client computing device re-encrypting the game asset using the asset key, the game key, and/or a client key associated with the client computing device. In some implementations, the client computing device may be configured to re-encrypt the game asset using at least a client key. In implementations utilizing a client key, the client key may be derived from attributes associated with the client computing device. For example, the attributes associated with the client computing device may include at least one of a CPU type, a GPU type, an amount of physical RAM and/or VRAM, a size of a physical hybrid hard drive (HDD) or solid-state drive (SSD), a hard disk serial number, a MAC ID of a network card, and a volume serial number.

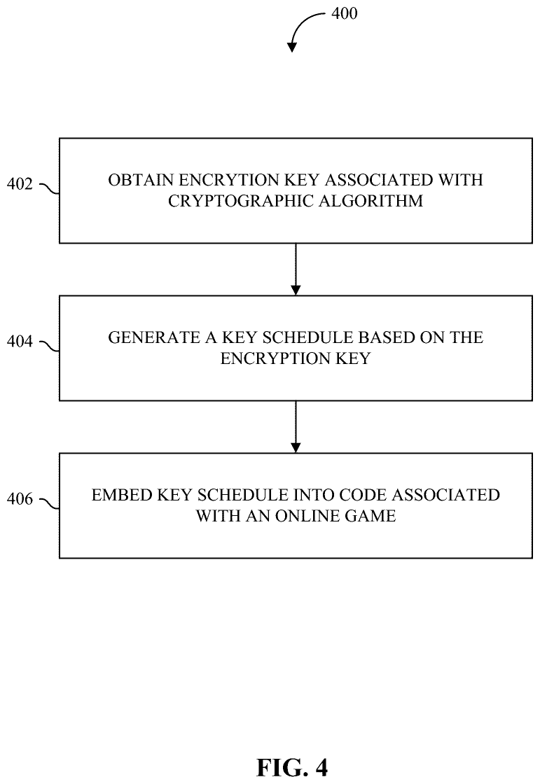

FIG. 4 illustrates an example of a process 400 for protecting a game asset for an online game by obfuscating an encryption key using a key schedule, according to one or more aspects described herein. The operations of process 400 presented below are intended to be illustrative and, as such, should not be viewed as limiting. In some implementations, process 400 may be accomplished with one or more additional operations not described, and/or without one or more of the operations discussed. In some implementations, two or more of the operations of process 400 may occur substantially simultaneously. The described operations may be accomplished using some or all of the system components described in detail above.

In an operation 402, process 400 may include obtaining an encryption key associated with a cryptographic algorithm. In some implementations, the cryptographic algorithm may comprise an Advanced Encryption Standard (AES) algorithm. In other implementations, the cryptographic algorithm may comprise a Twofish algorithm or a Speck algorithm. In an operation 404, process 400 may include generating a key schedule based on the encryption key. In an operation 406, process 400 may include embedding the key schedule into code associated with an online game, wherein the key schedule is used to decrypt a game asset encrypted using the cryptographic algorithm. In various implementations, the encryption key is not embedded in the code associated with the online game. Indeed, in such implementations, the code associated with the online game may not include the encryption key. Instead, the code associated with the online game may rely on the key schedule derived from the encryption key to decrypt game assets at the client computing device. In some embodiments, key schedule may be further obfuscated as described herein.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific example aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application-such as by using any combination of digital processors, analog processors, digital circuits designed to process information, central processing units, graphics processing units, microcontrollers, microprocessors, field programmable gate arrays (FPGAs), application specific transformed circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112 as well as data that may be manipulated by processor(s) 112. The electronic storage may comprise floppy disks, hard disks, optical disks, tapes, or other storage media for storing computer-executable instructions and/or data.

Although illustrated in FIG. 1 as a single component, client computer system 110 and game server 210 may each include a plurality of individual components (e.g., computer devices) each programmed with at least some of the functions described herein. In this manner, some components of client computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112 include multiple processing units, one or more instructions may be executed remotely from the other instructions.

One or more components of system 100 may communicate with each other through hard-wired communication, wireless communication, or both. In various implementations, one or more components of system 100 may communicate with each other through a network. For example, client computer system 110 and/or game server 210 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Although client computer system 110, electronic storage 130, and game server 210 are shown to be connected to interface 102 in FIG. 1, any communication medium may be used to facilitate interaction between any components of system 100. For example, as referred to herein, interface 102 may comprise a network via which client computer system 110 may transmit packets or otherwise communicate with game server 210. In some implementations, the connections forming the network represented by interface 102 may include Asymmetric Digital Subscriber Line (ADSL), Symmetric Digital Subscriber Line (SDSL), cable, 3G, 4G, LTE, Ethernet, or any other existing or future developed systems and/or methods of communication with similar functionalities. In some implementations, one or multiple connections may be used to facilitate communication (e.g., transmit packets) between client computer system 110 and game server 210. Indeed, while described herein as a single interface 102 for simplicity, interface 102 may include one or multiple physical and/or virtual interfaces via which packets may be sent from client computer system 110 to game server 210, and vice versa. For example, multiple connections forming a Local Area Network (LAN), Intranet, or Internet may be used to facilitate communication between client computer system 110 and game server 210.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented method of performing obfuscated encryption of game assets in online games, the method comprising:
generating, by a game server, code for encrypting a game asset using a bijective function, wherein the code consists of bijection primitives, wherein at least one of the bijection primitives comprises an encryption algorithm;
encrypting, by the game server, the game asset using the generated code, wherein the encrypted game asset is configured to be decrypted at a client computing device using the generated code; and
transmitting, by the game server, the encrypted game asset to the client computing device.

2. The computer-implemented method of claim 1, wherein generating the code comprises using the bijective function to pseudo-randomly generate parameters corresponding to each of the bijection primitives.

3. The computer-implemented method of claim 1, wherein at least one of the bijection primitives comprises symmetric encryption in counter (CTR) mode.

4. The computer-implemented method of claim 3, wherein a counter parameter associated with CTR mode is external to the generated code

5. The computer-implemented method of claim 1, wherein an encryption key associated with the encryption algorithm is provided external to the generated code.

6. The computer-implemented method of claim 1, wherein an encryption key associated with the encryption algorithm is embedded within the generated code.

7. The computer-implemented method of claim 6, wherein the encryption key associated with the encryption algorithm is obfuscated prior to being embedded within the generated code.

8. The computer-implemented method of claim 1, wherein code for the encryption algorithm is obfuscated using one or more bijection primitives.

9. The computer-implemented method of claim 1, the method further comprising compiling the generated code into bytecode form, wherein the resulting bytecode is provided instead of an encryption key.

10. A system for performing obfuscated encryption of game assets in online games, the system comprising:
a game server having one or more processors configured by computer readable instructions to:
generate code for encrypting a game asset using a bijective function, wherein the code consists of bijection primitives, wherein at least one of the bijection primitives comprises an encryption algorithm;
encrypt the game asset using the generated code, wherein the encrypted game asset is configured to be decrypted at a client computing device using the generated code; and
transmit the encrypted game asset to the client computing device.

11. The system of claim 10, wherein to generate the code, the one or more processors are configured to use the bijective function to pseudo-randomly generate parameters corresponding to each of the bijection primitives.

12. The system of claim 10, wherein at least one of the bijection primitives comprises symmetric encryption in counter (CTR) mode.

13. The system of claim 12, wherein a counter parameter associated with CTR mode is external to the generated code

14. The system of claim 10, wherein an encryption key associated with the encryption algorithm is provided external to the generated code.

15. The system of claim 10, wherein an encryption key associated with the encryption algorithm is embedded within the generated code.

16. The system of claim 15, wherein the encryption key associated with the encryption algorithm is obfuscated prior to being embedded within the generated code.

17. The system of claim 10, wherein code for the encryption algorithm is obfuscated using one or more bijection primitives.

18. The system of claim 10, wherein the one or more processors are further configured to compile the generated code into bytecode form, wherein the resulting bytecode is provided instead of an encryption key.

19-50. (canceled)
